(19) United States
(12) Patent Application Publication
(10) Pub. No.: US 2014/0338614 A1
(43) Pub. Date: Nov. 20, 2014

(54) MODULAR TRACK SYSTEM FOR ANIMALS

(71) Applicant: Nicholas Carl Grubaugh, Ashland, VA (US)

(72) Inventor: Nicholas Carl Grubaugh, Ashland, VA (US)

(21) Appl. No.: 13/897,329

(22) Filed: May 17, 2013

(51) Int. Cl. A01K 29/00

(52) U.S. Cl. CPC A01K 29/00
USPC 119/712

(57) ABSTRACT

A modular track system can be applied to a surface to provide a track that holds an insert. The insert can provide a scent that can attract an animal, such as a pet cat or dog, and provide the animal with a path they can follow. The track system can be especially useful for providing a path for blind pets. The insert can include a heating element, where the track system can be used about a perimeter of an outdoor dog house to provide heat to a pet. The track system can include a base member that can be secured by an adhesive, a fastener, or through a blade that can be inserted into the ground. The base member can secure the insert therewithin and a perforated top cover can be disposed over the base member and insert to prevent direct access to the insert by the pet.

### BACKGROUND OF THE INVENTION

The present invention relates to track systems for animals and, more particularly, to a modular track system that can be used to guide or repel animals.

When a pet loses its eyesight, it can be very difficult for them to find their way around a house and outdoors. While blind animals often have a good sense of various items location, they can injure themselves by running into items that may have moved or that the pet simply doesn't realize is there.

Blind pets, such as dogs and cats, typically still have a good sense of smell. Such animals often use this to help guide them, however, many obstacles can lack a smell and can cause problems.

To keep animals out of certain areas, people sometimes rely on items having a certain smell. However, these items are often provided in a spray or other medium that can be blown or washed away.

As can be seen, there is a need for a device that can provide a scent for an animal that can guide the animal along a certain path or away from a given area.

### SUMMARY OF THE INVENTION

In one aspect of the present invention, a modular track system for animals comprises a base unit; a fastening mechanism for attaching the base unit to a surface; an insert fitting into the base unit; a top cover fitting over the base unit; and means for interconnecting a first base unit with an adjacent, second base unit.

These and other features, aspects and advantages of the present invention will become better understood with reference to the following drawings, description and claims.

### BRIEF DESCRIPTION OF THE DRAWINGS

FIG. 1 is a perspective view of a segment of a modular track system according to an exemplary embodiment of the present invention;

FIG. 2 is a perspective view of a segment of a modular track system according to another exemplary embodiment of the present invention, where a blade can be used for securing a base unit in place;

FIG. 3 is an exploded perspective view of a modular track system that can be secured by fasteners to a surface;

FIG. 4 is a plan view of an exemplary track design for inside and outside of a home;

FIG. 5 is a cross-sectional view of the modular track system shown in FIG. 1, illustrating an adhesive placement of the base unit;

FIG. 6 is a detail cross-sectional view of the modular track system taken along line 6-6 of FIG. 5;

FIG. 7 is a cross-sectional view of the modular track system shown in FIG. 3;

FIG. 8 is a cross-sectional view of the modular track system shown in FIG. 2;

FIG. 9 is a detailed cross-sectional view of the modular track system taken along line 9-9 of FIG. 8;

FIG. 10 is a perspective view of an alternate use of the track system of the present invention; and

FIG. 11 is a cross sectional view taken along line 11-11 of FIG. 10.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a modular track system that can be applied to a surface to provide a system to hold an insert. The insert can provide a scent that can attract an animal, such as a pet cat or dog, and provide the animal with a path they can follow. The track system can be especially useful for providing a path for blind pets. In some embodiments, the insert can be a heating element, where the track system can be used about a perimeter of an outdoor dog house to provide heat to a pet. The track system can include a base member that can be secured by an adhesive, a fastener, or through a blade that can be inserted into the ground. The base member can secure the insert therewithin and a perforated top cover can be disposed over the base member and insert to prevent direct access to the insert by the pet.

Referring now to FIGS. 1 through 9, a modular track system 10 can include one or more modular units (as shown in FIG. 1) interconnected together to form a track system 32. The modular track system 10 can include a base unit 12 formed in a flattened C-shape. The base unit 12 can include a means for attaching multiple base units together. In some embodiments, one side of the base unit 12 can include coupling prongs 22 and the other side of the base unit can include receptacles 24 for receiving the prongs 22.

The base unit 12 can attach to various surfaces by various manners. In some embodiments, an adhesive 34 can be used to attach the base unit 12 to a surface, such as a tile floor. In other embodiments, mounting holes 26 can be provided through the base unit 12 where fasteners, such as screws 28, can be used to pass through the mounting holes 26 and secure the base unit 12 to a surface, such as a wooden floor. In other embodiments, a blade 20 can extend from the bottom of the base unit 12. The blade 20 can be pressed into a surface, such as the ground, to secure the base unit 12 thereto.

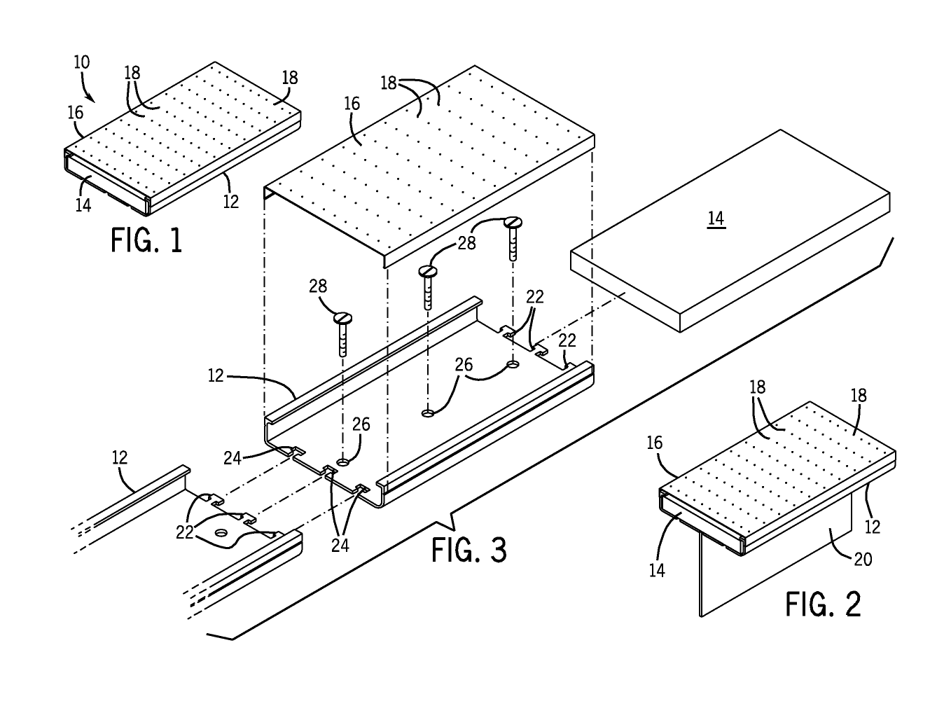

An insert 14 can be disposed in the base unit 12. In some embodiments, the insert 14 can be slid into and secured within the base unit 12 due to its flattened C-shape, as shown in FIG. 3. The insert 14 can be a material that can hold a scent. The scent can be designed to attract pets (useful in a system, for example, to guide blind pets) or can be used to repel certain animals (useful in a system, for example, to repel deer from a garden). The scented insert can be designed in various shapes and sizes, depending on user needs and application.

A top cover 16 can be disposed over the base unit 12 and insert 14. A plurality of perforations 18 can be cut through the top cover 16 to permit the scent in the insert 14 to be detected therethrough. The top cover 16 can be secured to the base unit 12 via various mechanisms. For example, as shown in FIG. 9, the top cover can include a rail 38 formed along the edge of thereof. A groove 36 can be formed in the base unit 12 to receive the rail 38 and secure the top cover 16 to the base unit 12.

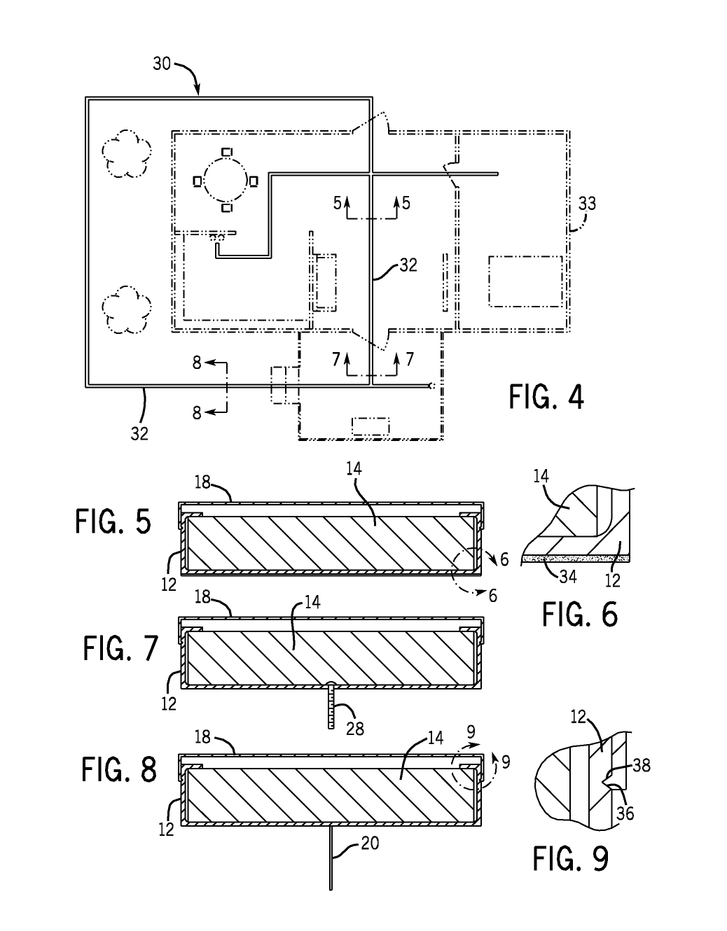

As shown in FIG. 4, the modular track system 10 can be placed in a layout 30 to form a track 32 that can be placed both inside and outside of a home perimeter 33. A blind pet can easily find the track 32 and be guided therealong to come in and out of the home. The scent placed in the insert 14 can be varied if desired. For example, the scent can be different at a door, steps, or the like, alerting the pet of the approaching hazard.

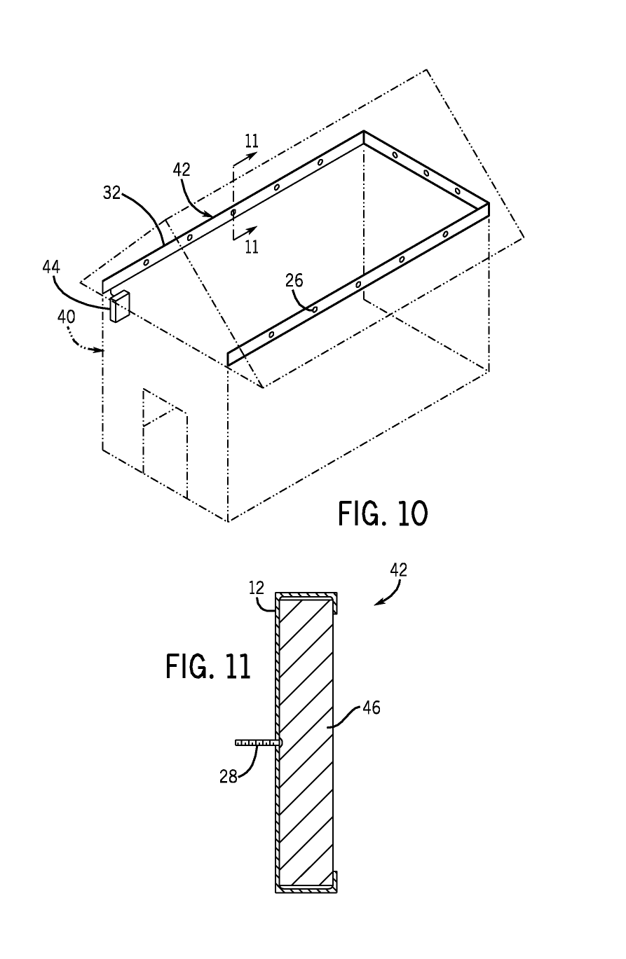

Referring now to FIGS. 10 and 11, in some embodiments, the insert 14 can be modified to include a heating element insert 46. The heating element insert 46 can be similar to the insert 14, fitting into the base unit 12. The resulting track system 42 can be placed, for example, about a perimeter of a dog house 40 to provide heat to a pet therein. A battery 44, or some other power supply, can provide power to the heating element insert 46.

Other inserts can be used inside the base unit 12, such as lights (for example, LED lights), or the like. In some embodiments, the inserts can include lights and a scent, lights and a heating element, or the like. In some embodiments, as insect repellent can be included in some or all of the inserts.

The base unit can be made in various sizes and shapes, depending on the application and the needs of the user.

It should be understood, of course, that the foregoing relates to exemplary embodiments of the invention and that modifications may be made without departing from the spirit and scope of the invention as set forth in the following claims.

What is claimed is:

1. A modular track system for animals, comprising:
a base unit;
a fastening mechanism for attaching the base unit to a surface;
an insert fitting into the base unit;
a top cover fitting over the base unit; and
means for interconnecting a first base unit with an adjacent, second base unit.

2. The modular track system of claim 1, wherein the base unit has a flattened C-shape.

3. The modular track system of claim 1, wherein the fastening mechanism includes a plurality of mounting holes with mounting fasteners passing through the mounting holes and into the surface.

4. The modular track system of claim 1, wherein the fastening mechanism includes an adhesive disposed along a bottom surface of the base unit.

5. The modular track system of claim 1, wherein the fastening mechanism includes a blade extending from a bottom surface of the base unit.

6. The modular track system of claim 1, further comprising:
a groove cut into the base unit; and
a rail formed on the top cover, wherein
the rail fits into the groove to secure the top cover on the base unit.

7. The modular track system of claim 1, wherein the insert is scented.

8. The modular track system of claim 1, wherein the insert is scented to attract a pet.

9. The modular track system of claim 1, wherein the insert is scented to repel animals.

10. The modular track system of claim 1, wherein the insert includes a heating element.

11. The modular track system of claim 10, further comprising a power supply for providing power to the heating element.

12. The modular track system of claim 1, wherein the top cover has a plurality of holes formed therethrough.

13. The modular track system of claim 1, wherein the means for interconnecting the first base unit with the adjacent, second base unit includes coupling prongs disposed on a first side of the base unit and receptacles, adapted to receive the coupling prongs, disposed on a second, opposite side of the base unit.
